(19) United States
(12) Patent Application Publication
(10) Pub. No.: US 2025/0303747 A1
(43) Pub. Date: Oct. 2, 2025

(54) PRINTER, METHOD, AND STORAGE MEDIUM

(71) Applicant: Toshiba Tec Kabushiki Kaisha, Tokyo (JP)

(72) Inventor: Mitsuhiro KATAOKA, Singapore (SG)

(21) Appl. No.: 19/046,455

(22) Filed: Feb. 5, 2025

(30) Foreign Application Priority Data
Mar. 26, 2024 (JP) 2024-050104

(51) Int. Cl. B41J 2/505; B41J 29/393

(52) U.S. Cl. CPC B41J 2/5056; B41J 29/393

(57) ABSTRACT

A printer includes a roller that conveys a sheet in a conveyance direction; a motor that drives the roller; a print head disposed along a line direction intersecting the conveyance direction; and a processor configured to set print speeds for dot data sets of lines to be printed based on a number of dots to be printed in each of the dot data sets, change the set print speeds of target dot data sets among the dot data sets to a uniform print speed when the set print speeds of the dot data sets change multiple times within a predetermined number of consecutive lines, and control the print head to print the dot data sets line by line on the sheet while controlling the motor to cause the roller to convey the sheet toward the print head at the set print speeds and the uniform print speed.

### CROSS-REFERENCE TO RELATED APPLICATION

This application is based upon and claims the benefit of priority from Japanese Patent Application No. 2024-050104, filed Mar. 26, 2024, the entire contents of which are incorporated herein by reference.

### FIELD

Embodiments described herein relate generally to a printer, a method, and a storage medium.

### BACKGROUND

A known printer prints characters and the like on a sheet using a print head including multiple heating elements that are arranged in a width direction (hereinafter also referred to as a line direction) intersecting the conveyance direction of the sheet. For example, there is a thermal printer that performs printing by applying heat to thermal paper. Also, for example, there is a thermal transfer printer that heats an ink ribbon to perform printing on a sheet.

In such a printer, print target information, such as characters, is printed line by line on the basis of print data representing the print target information in dots. Print data for each line (hereinafter also referred to as a dot data set) specifies heating elements corresponding to dots (hereinafter also referred to as print dots) to be printed on the line. The heating elements corresponding to the print dots are heated to print the print dots on a sheet being conveyed.

Here, the number and the ratio (hereinafter also referred to as a print ratio) of print dots in each dot data set are related to power consumption. Specifically, as the print ratio increases, the number of heating elements to be heated increases, and therefore, power consumption increases. Also, a rated output (or power supply) is specified for a printer. Therefore, in a printer, power consumption is generally controlled within the specified rated output by setting a print speed corresponding to the print ratio for each line.

However, with the related art, when the print ratio frequently changes during printing of print data, the speed of a motor related to the conveyance of a sheet frequently changes. This may cause the motor to lose synchronization and may degrade printing quality. Therefore, there is a demand for a technology that makes it possible to efficiently perform printing even when the print ratio frequently changes in print data.

### SUMMARY OF THE INVENTION

Embodiments of the present invention provide a printer, a method, and a storage medium that make it possible to efficiently perform printing even when the print ratio frequently changes in print data.

According to an aspect of the present disclosure, a printer includes a roller that conveys a sheet in a conveyance direction; a motor that drives the roller; a print head disposed along a line direction intersecting the conveyance direction; and a processor configured to set print speeds for dot data sets of lines to be printed based on a number of dots to be printed in each of the dot data sets, change the set print speeds of target dot data sets among the dot data sets to a uniform print speed when the set print speeds of the dot data sets change multiple times within a predetermined number of consecutive lines, and control the print head to print the dot data sets line by line on the sheet while controlling the motor to cause the roller to convey the sheet toward the print head at the set print speeds and the uniform print speed.

### BRIEF DESCRIPTION OF THE DRAWINGS

FIG. 1 is a schematic diagram illustrating a configuration of a printer according to an embodiment.

FIG. 2 is a diagram illustrating an example of a hardware configuration of the printer.

FIG. 3 is a diagram for explaining a relationship between print ratios of print dots and print speeds.

FIG. 4 is a diagram for explaining a relationship between print ratios of print dots and print speeds.

FIG. 5 is a diagram illustrating an example of a functional configuration of the printer.

FIGS. 6A, 6B, and 6C are diagrams for explaining an example of print speed control performed by a print speed control unit.

FIG. 7 is a flowchart illustrating an example of a print speed control process performed by the printer.

### DETAILED DESCRIPTION

Hereinafter, embodiments will be described in detail with reference to the drawings. The present disclosure is not limited to the embodiments described below.

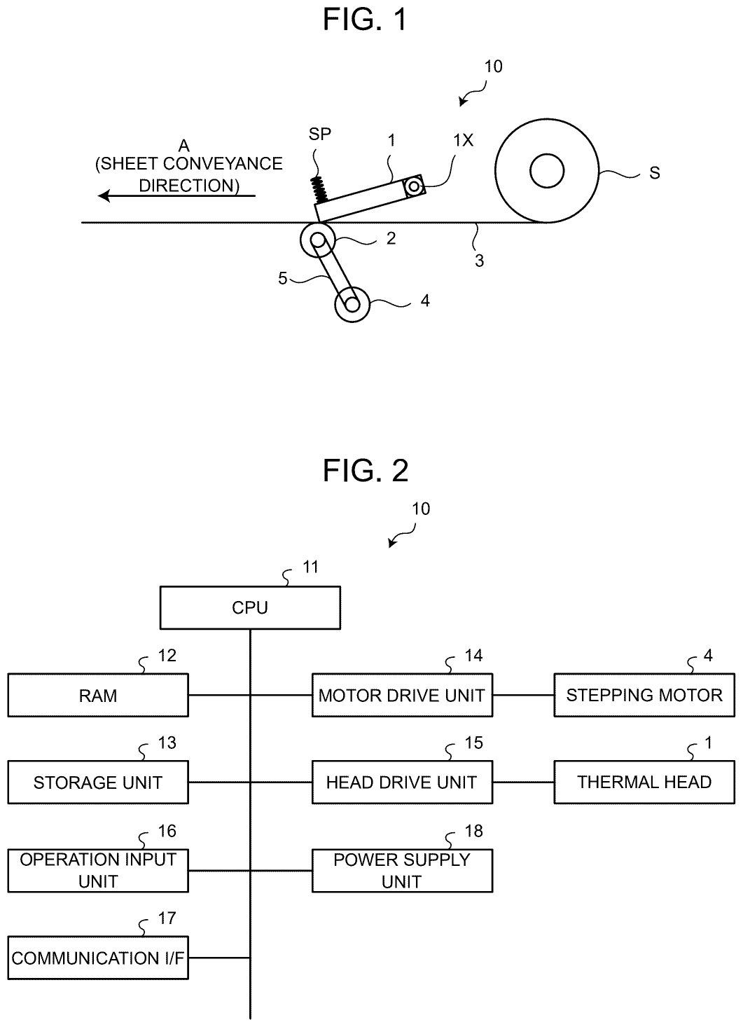

FIG. 1 is a schematic diagram illustrating a configuration of a printer 10 according to an embodiment. As illustrated in FIG. 1, the printer 10 includes a thermal head 1 and a platen roller 2. The thermal head 1 and the platen roller 2 are disposed opposite to each other to sandwich a sheet 3, which is a recording medium, supplied from a continuous sheet roll S.

The thermal head 1 is an example of a print head. One end of the thermal head 1 is supported by a rotation shaft 1X to be rotatable around the rotation shaft 1x as a rotation center. The thermal head 1 is biased by a biasing member SP so that the other end of the thermal head 1 is pressed against the platen roller 2.

The platen roller 2 is an example of a roller that conveys the sheet 3 in a conveyance direction. A stepping motor 4 is provided to supply a rotational driving force to the platen roller 2. The stepping motor 4 is an example of a drive device or a motor that drives the platen roller 2. Specifically, the platen roller 2 is connected to the stepping motor 4 via a belt 5 that transmits the rotational driving force of the stepping motor 4 to the platen roller 2. When the stepping motor 4 rotates, the platen roller 2 is rotated by the belt 5 in conjunction with the rotation of the stepping motor 4.

The sheet 3 is an example of a printing medium. The sheet 3 is, for example, a heat-sensitive sheet, such as a label sheet. The sheet 3 is conveyed in the leftward direction (or a sheet conveyance direction A) in FIG. 1 when the platen roller 2 rotates while the sheet 3 is sandwiched between the thermal head 1 and the platen roller 2.

The thermal head 1 includes multiple heating elements (not shown) arranged in the width direction (or line direction) of the sheet 3 that intersects the conveyance direction of the sheet 3. The thermal head 1 causes heating elements, which correspond to positions on the sheet 3 at which dots (hereinafter also referred to as print dots) are to be printed, to generate heat. With this configuration, the thermal head 1 prints print dots on the sheet 3 being conveyed, according to print data, which represents, for example, characters, for each of lines (or dot data sets described later) constituting the print data. In the present embodiment, “printing” includes not only the printing of characters and symbols but also the printing of images.

The printer 10 inputs strobe signals to the heating elements of the thermal head 1 to cause the heating elements to generate heat. The printer 10 applies the heat to the sheet 3 to cause the sheet 3 to produce color and thereby prints an image corresponding to print data on the sheet 3.

Note that the configuration of the printer 10 is not limited to that illustrated in FIG. 1. For example, the printer 10 may further include a roller for pulling out the sheet 3 from the continuous sheet roll S and feeding the pulled-out sheet 3 to the platen roller 2 and a cutter mechanism for cutting a printed sheet 3. Also, in the present embodiment, a conveyance mechanism, which conveys the sheet 3, includes the platen roller 2, the stepping motor 4, and a motor drive unit 14 (see FIG. 2) described later. However, the present disclosure is not limited to this example, and the conveyance mechanism may also include other components, such as a roller for pulling out the sheet 3 and a driving source for the roller. Furthermore, any or all of the platen roller 2, the stepping motor 4, and the motor drive unit 14 may be referred to as a conveyance mechanism that conveys the sheet 3.

FIG. 2 is a diagram illustrating an example of a hardware configuration of the printer 10. As illustrated in FIG. 2, the printer 10 includes a computer configuration including a CPU (Central Processing Unit) 11, a RAM (Random Access Memory) 12, and a storage unit 13.

The CPU 11 is an example of a processor and centrally controls respective components of the printer 10. The RAM 12 is a volatile storage medium and is used as a workspace of the CPU 11. For example, the RAM 12 is used as a buffer area for temporarily storing print data to be printed on the sheet 3.

The storage unit 13 is a nonvolatile storage medium such as a ROM (Read-Only Memory) or a flash memory. The storage unit 13 stores various programs executed by the CPU 11 and setting information. For example, the storage unit 13 stores a program related to a print speed control process described later. For example, the storage unit 13 stores setting information defining a relationship between print ratios and print speeds described later.

Programs to be executed by the printer 10 of the present embodiment may be recorded in a non-transitory computer-readable storage medium, such as a CD-ROM, a flexible disk (FD), a CD-R, or a DVD (Digital Versatile Disk), in an installable format or an executable format.

Also, programs to be executed by the printer 10 of the present embodiment may be stored in a computer connected to a network, such as the Internet, and downloaded via the network. Furthermore, programs to be executed by the printer 10 of the present embodiment may be provided or distributed via a network such as the Internet.

A motor drive unit 14 and a head drive unit 15 are connected to the CPU 11. The motor drive unit 14 and the head drive unit 15 are examples of drive control units.

The motor drive unit 14 controls the operation of the stepping motor 4 by energizing the stepping motor 4. Specifically, the motor drive unit 14 generates a pulse signal (or a current waveform) for driving (or rotating) the stepping motor 4 under the control of the CPU 11. In other words, the CPU 11 (or the processor of the printer 10) is configured to control the stepping motor 3. Then, the motor drive unit 14 rotates the stepping motor 4 by exciting the stepping motor 4 using the generated current waveform.

The head drive unit 15 controls the operation of the thermal head 1 by energizing the thermal head 1. Specifically, the head drive unit 15 generates pulse signals (strobe signals) for driving the thermal head 1 (or causing the thermal head 1 to generate heat) under the control of the CPU 11. In other words, the CPU 11 (or the processor of the printer 10) is configured to control the thermal head 1. Then, the head drive unit 15 causes the heating elements of the thermal head 1 to generate heat by using the generated strobe signals.

Also, an operation input unit 16 and a communication interface (I/F) 17 are connected to the CPU 11. The operation input unit 16 includes various keys for the user to operate the printer 10. An operation performed via the operation input unit 16 is input to the CPU 11. For example, when an operation for instructing the start of printing is performed via the operation input unit 16, the CPU 11 controls the motor drive unit 14 and the head drive unit 15 to start printing on the sheet 3.

The communication interface 17 is an interface for communicating with a host device (or an external device), such as a POS terminal. The communication interface 17 is, for example, an infrared communication interface, such as an IrDA device, a USB (Universal Serial Bus) interface, a LAN (Local Area Network) interface, an RS-232C interface, or a Bluetooth (registered trademark) interface. The CPU 11 transmits and receives various types of data to and from a host device via the communication interface 17.

For example, the CPU 11 acquires print data transmitted from a host device via the communication interface 17. The acquired print data is temporarily stored in the RAM 12, and images corresponding to the print data are printed on the sheet 3 under the control of the CPU 11. More specifically, the CPU 11 controls the motor drive unit 14 to rotate the stepping motor 4 to convey the sheet 3 in the sheet conveyance direction A. Also, the CPU 11 controls the operation of the head drive unit 15 based on the print data to print images corresponding to the print data on the sheet 3 conveyed in the sheet conveyance direction A.

The printer 10 further includes a power supply unit 18. The power supply unit 18 is detachably connected to a commercial power supply (not shown) via a connector (for example, a connection plug or an outlet). The power supply unit 18 converts an AC voltage supplied from the commercial power supply into a DC voltage usable by the printer 10, and then supplies the DC voltage to each component of the printer 10 via a power supply line (not shown). Note that the power supply unit 18 may include a power switch for switching on and off the electrical connection with the commercial power supply.

Next, among printing processes performed by the CPU 11 of the printer 10 in accordance with programs, a print speed control process will be described.

In the printer 10, print dots are printed line by line on the basis of print data representing print target information, such as characters, in dots. Print data for each line (hereinafter also referred to as a dot data set) specifies heating elements corresponding to print dots to be printed on the line, and the print dots are printed by causing the corresponding heating elements to generate heat.

Here, the number, the ratio, and the density of print dots (hereinafter also collectively referred to as a print ratio) in each dot data set are related to power consumption. Specifically, as the print ratio increases, the number of heating elements caused to generate heat increases, and therefore power consumption increases. For the printer 10, a rated output (or power supply) is specified. Therefore, in the printer 10 of the present embodiment, a print speed control process is performed to suppress power consumption within the specified rated output by changing the print speed or the conveyance speed of the sheet 3 in accordance with the print ratio.

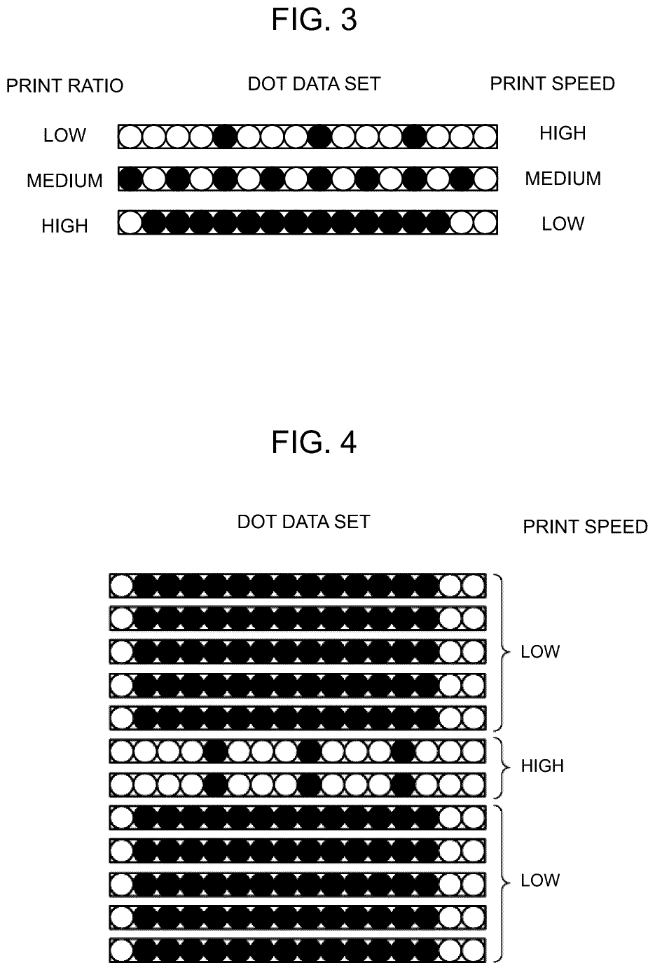

Here, a relationship between print ratios of print dots and print speeds will be described with reference to FIGS. 3 and 4. FIG. 3 and FIG. 4 are diagrams for explaining a relationship between print ratios of print dots and print speeds.

In FIG. 3, sixteen dots represent a dot data set for each line. Also, black circles represent print dots to be printed, and white circles represent dots (hereinafter also referred to as non-print dots) not to be printed.

Print ratios of print dots are categorized into multiple levels based on, for example, the number of print dots included in each dot data set, the ratio between print dots and non-print dots, and the like. FIG. 3 shows an example in which print ratios are categorized into three levels: low, medium, and high. In this case, the power consumption of the thermal head 1 (or heating elements) increases in the order of low, medium, and high. Therefore, in the print speed control process, as shown in FIG. 3, the print speed and the power related to the conveyance of the sheet 3 are decreased as the print ratio increases so that the power consumption falls within the specified rated output.

However, when the print ratio frequently changes, the speed of the stepping motor 4 related to the conveyance of the sheet 3 also frequently changes. As a result, the stepping motor 4 may step out, and the printing quality may be degraded. For example, as shown in FIG. 4, when the print ratio changes from high to low and then to high in multiple dot data sets for multiple consecutive lines, the print speed changes from low to high and then to low in a short period of time. This may cause the stepping motor 4 to step out.

Therefore, the printer 10 of the present embodiment has a functional configuration that keeps the print speed constant when the print ratio frequently changes so that the speed of the stepping motor 4 does not frequently change.

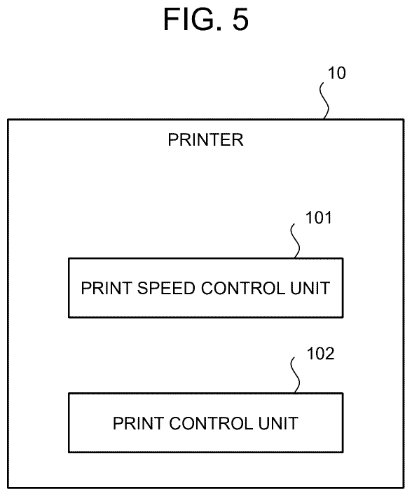

Next, a functional configuration of the printer 10 related to printing will be described with reference to FIG. 5. FIG. 5 is a diagram illustrating an example of a functional configuration of the printer 10. As illustrated in FIG. 5, the printer 10 includes a print speed control unit 101 and a print control unit 102 as functional components.

As an actual hardware configuration, the CPU 11 of the printer 10 reads a program from the storage unit 13, loads the program into the RAM 12, and executes the program to implement the print speed control unit 101 and the print control unit 102 in the RAM 12. In other words, the processor of the printer 10 is configured to perform the operations of the print speed control unit 101 and the print control unit 102. Note that the print speed control unit 101 and the print control unit 102 are not limited to software components implemented by the cooperation between the CPU 11 and the program and may also be implemented by hardware components, such as dedicated circuits.

The print speed control unit 101 is an example of a setting unit and a changing unit. The print speed control unit 101 sets print speeds corresponding to the print ratios of dot data sets of lines constituting print data and thereby controls the print speeds of the dot data sets.

When the print speeds change multiple times within a predetermined number of consecutive lines, the print speed control unit 101 changes the set print speeds of target dot data sets among the dot data sets to a uniform print speed. Specifically, when a speed change involving a change in the speed change direction is detected in dot data sets within the predetermined number of consecutive lines, the print speed control unit 101 changes the print speeds of target dot data sets of lines related to the speed change to a uniform print speed.

Here, the speed change direction means an upward change in the print speed or a downward change in the print speed. A change in the speed change direction means that the print speed that has been increasing starts to decrease or that the print speed that has been decreasing starts to increase. The stepping motor 4 is unlikely to step out while the speed change direction of the print speed is the same but is likely to step out when the speed change direction frequently changes. Therefore, by detecting a change in the speed change direction, it is possible to control the print speed focusing on a speed change that is likely to cause the stepping motor 4 to step out.

Note that the upper limit of the number of consecutive lines (that is, the predetermined number of consecutive lines, hereinafter also referred to as the number of target lines) used for the detection of a speed change is not limited to any particular value. However, the upper limit of the number of target lines (or the predetermined number of lines) is preferably set, based on the specification of the stepping motor 4, to such a number of lines that the stepping motor 4 tends to step out when the print speed frequently changes within the number of lines.

A threshold for detecting a speed change may also be set to any appropriate value. For example, when the print speed is categorized into three levels as described above, a one-level speed change (e.g., from low to medium) may be set as the threshold, or a two-level speed change (e.g., from low to high) may be set as the threshold.

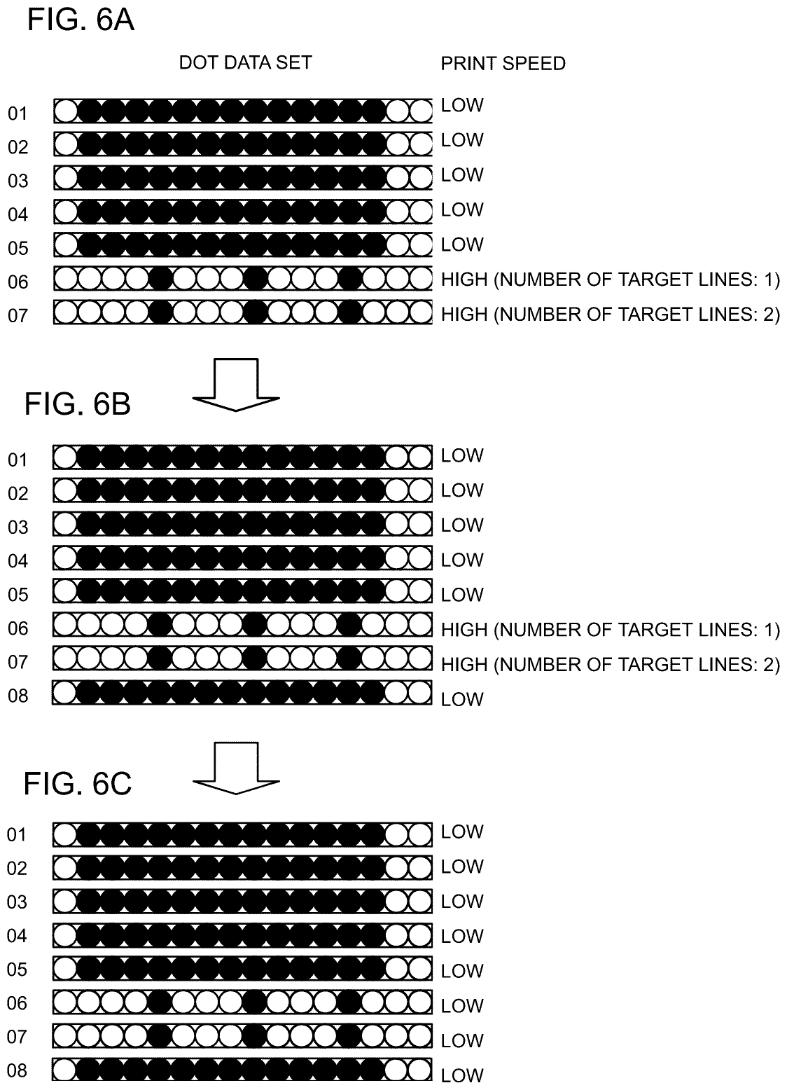

Here, an example an operation of the print speed control unit 101 will be described with reference to FIGS. 6A, 6B, and 6C. FIGS. 6A, 6B, and 6C are diagrams for explaining an example of print speed control performed by the print speed control unit 101.

Dot data sets illustrated in FIGS. 6A, 6B, and 6C are read from print data by the print speed control unit 101. The numbers assigned to the left of the dot data sets indicate the order in which the dot data sets are read by the print speed control unit 101 and correspond to the printing order of the dot data sets. That is, in FIGS. 6A, 6B, and 6C, printing is performed from the upper dot data set to the lower dot data set. In FIGS. 6A, 6B, and 6C, it is assumed that the upper limit of the number of target lines is “10”, and the threshold for detecting a speed change is set to two levels.

First, the print speed control unit 101 calculates print ratios for respective dot data sets constituting the print data, and sets print speeds corresponding to the print ratios for the dot data sets. For example, as illustrated in FIG. 6A, because the print ratios of dot data sets “01” to “05” are “high”, the print speed control unit 101 sets a print speed “low” as speed information for each of dot data sets “01” to “05”.

Because the print ratio of subsequent dot data set “06” is “low”, the print speed control unit 101 sets a print speed “high” as speed information. Also, the print speed control unit 101 detects that the print speed has changed from “low” to “high” and starts counting the number of target lines.

Because the print ratio of subsequent dot data set “07” is “low” as in the case of dot data set “06”, the print speed control unit 101 sets a print speed “high” as speed information. Also, the print speed control unit 101 sets the count of the number of target lines to “2” for dot data set “07”.

Next, when dot data set “08” is read as illustrated in FIG. 6B, the print speed control unit 101 determines that the print ratio of dot data set “08” is “high”. In this case, the print speed control unit 101 sets the print speed “low” corresponding to the print ratio “high” as speed information for dot data set “08”. Also, the print speed control unit 101 detects that the print speed has changed from “high” to “low”.

Because the print speed control unit 101 has detected a speed change from “low” to “high” at dot data set “06” preceding dot data set “08” and has detected a speed change from “high” to “low” at dot data set “08”, the print speed control unit 101 determines that the speed change direction has changed. Also, the print speed control unit 101 determines that the count of the number of target lines is within the upper limit because the count of the number of target lines is “2” at dot data set “08”. In this case, the print speed control unit 101 performs a process of changing the print speeds of dot data sets “06” to “08” related to the speed change to a uniform print speed.

For example, the print speed control unit 101 makes the print speed constant by using the lowest print speed “low” among the print speeds set for dot data sets “06” to “08” related to the speed change. Specifically, as illustrated in FIG. 6C, the print speed control unit 101 overwrites the speed information for each of dot data sets “06”, “07”, and “08” with the print speed “low”. Because the print speed of dot data set “08” is originally “low”, the original speed information may be maintained.

Accordingly, the print speed control unit 101 can set a uniform print speed (or speed information) for dot data sets (also referred to as target dot data sets) of lines from a line at which a change in the print speed is first detected to a line at which a change in the speed change direction is detected, that is, lines in which the stepping motor 4 is likely to step out. Here, it is assumed that the print speed control unit 101 prepares for detection of another speed change by clearing the count of the number of target lines after changing the print speeds to the uniform print speed.

In the example of the operation of the print speed control unit 101 described above with reference to FIGS. 6A, 6B, and 6C, it is assumed that the print speed changes from low to high and then to low. However, the print speed can also be made constant in a similar manner even when the print speed changes from high to low and then to high.

Also, in the example of FIGS. 6A, 6B, and 6C, the print speed is made constant using the lowest print speed among the print speeds set for the target dot data sets of lines related to the speed change. Alternatively, the print speed may be made constant at any other print speed. However, the print speed control unit 101 preferably determines the uniform print speed such that power consumption, which is determined according to the relationship between the print ratio and the print speed, falls within the specified rated output. With this configuration, the print speed control unit 101 can prevent the print speed from frequently changing and can keep the power consumption within the specified rated output.

Returning to FIG. 5, the print control unit 102 is described. The print control unit 102 controls the operations of the motor drive unit 14 and the head drive unit 15 to print print data.

Specifically, the print control unit 102 controls the driving of the stepping motor 4 via the motor drive unit 14 based on speed information set for each of lines constituting the print data and thereby causes the sheet 3 to be conveyed at a conveyance speed corresponding to the speed information.

More specifically, the print control unit 102 conveys the sheet 3 toward the thermal head 1 at a print speed based on the speed information set for each of dot data sets of lines constituting the print data. In addition, the print control unit 102 controls the driving of the thermal head 1 via the head drive unit 15 in accordance with the conveyance of the sheet 3 and causes heating elements corresponding to print dots in the dot data set of each line to generate heat and thereby perform printing of the dot data set of each line.

Accordingly, the print control unit 102 can print an image on the sheet 3 based on print data whose print speed is adjusted by the print speed control unit 101. Therefore, the print control unit 102 can perform printing of print data stably.

Note that the print speed control unit 101 performs the above-described print speed control process prior to the printing of print data by the print control unit 102. However, the print speed control unit 101 may be configured to perform the print speed control process in the background while printing is performed by the print speed control unit 101. In this case, the print control unit 102 sequentially prints dot data sets processed by the print speed control unit 101.

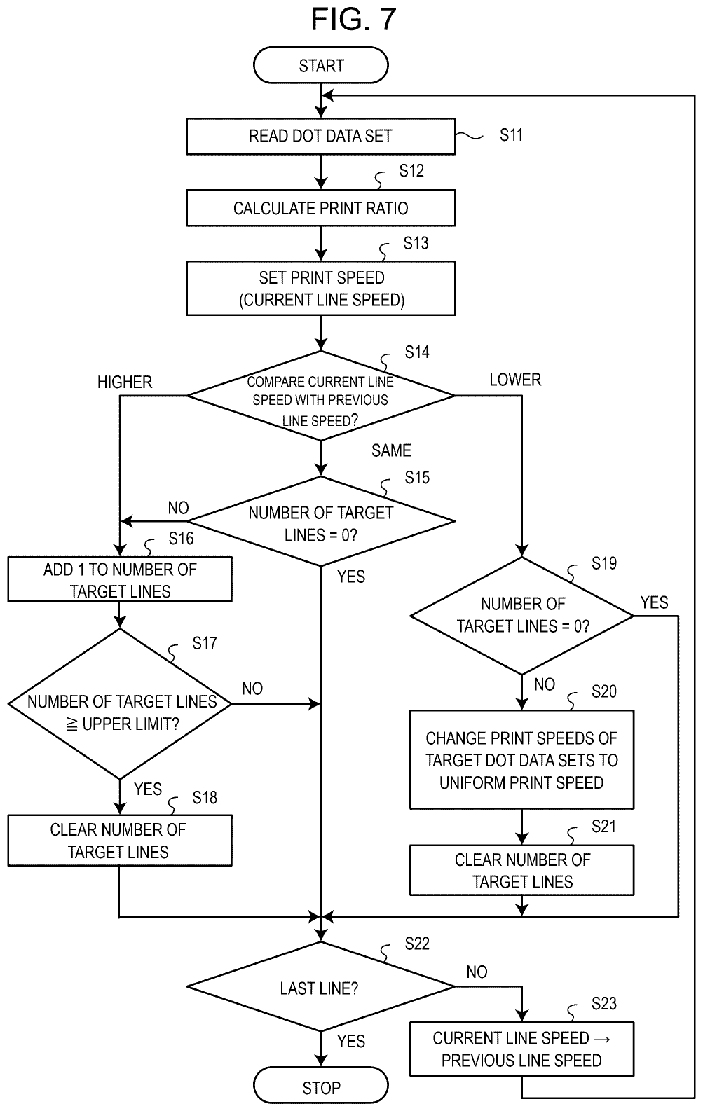

FIG. 7 is a flowchart illustrating an example of a print speed control process performed by the printer 10. The print speed control unit 101 of the printer 10 performs steps in the flowchart of FIG. 7. In other words, the processor of the printer 10 is configured to perform the steps in the flowchart of FIG. 7. In this example, it is assumed that the print speed changes from low to high and then to low as described with reference to FIGS. 6A, 6B, and 6C.

The print speed control unit 101 reads a dot data set of a line (hereafter also referred to as a current line) preceding in the printing order among lines constituting print data (step S11). Next, the print speed control unit 101 calculates the print ratio of the read dot data set (step S12) and sets a print speed corresponding to the calculated print ratio as speed information for the dot data set (step S13).

Subsequently, the print speed control unit 101 compares the print speed (hereinafter also referred to as a current line speed) set at step S13 with the print speed (hereinafter also referred to as a previous line speed) set for the previous line (step S14). When the current line speed and the previous line speed are the same (step S14: “SAME”), the print speed control unit 101 determines whether the number of target lines is zero (step S15).

When the number of target lines is zero (step S15: Yes), the print speed control unit 101 determines whether the current line is the last line in the print data (step S22). When the current line is not the last line (step S22: No), the print speed control unit 101 stores the current line speed set at step S13 as a previous line speed (step S23) and then returns to step S11.

When the number of target lines is not zero, that is, when the number of target lines is greater than zero (step S15: No), the print speed control unit 101 proceeds to step S16. Here, when the dot data set read at step S11 is the dot data set of the first line, the print speed control unit 101 determines that the current line speed is the same as the previous line speed at step S14 and determines that the number of target lines is zero at step S15.

When the current line speed is higher than the previous line speed (step S14: HIGHER), the print speed control unit 101 adds 1 to the number of target lines (step S16). Next, the print speed control unit 101 determines whether the number of target lines is greater than or equal to the upper limit (for example, 10 lines) (step S17).

When the number of target lines is less than the upper limit (step S17: No), the print speed control unit 101 proceeds to step S22. When the number of target lines is greater than or equal to the upper limit (step S17: Yes), the print speed control unit 101 clears the number of target lines (step S18) and then proceeds to step S22.

When the current line speed is lower than the previous line speed (step S14: LOWER), the print speed control unit 101 determines whether the number of target lines is zero (step S19). When the number of target lines is zero (step S19: Yes), the print speed control unit 101 proceeds to step S22.

On the other hand, when the number of target lines is not zero, that is, greater than zero (step S19: No), the print speed control unit 101 changes the print speeds of lines (or target dot data sets) related to the speed change to a uniform print speed (step S20). For example, the print speed control unit 101 changes the print speeds of the lines related to the speed change to the lowest print speed among the print speeds of the lines related to the speed change. Subsequently, the print speed control unit 101 clears the number of target lines (step S21) and then proceeds to step S22.

When determining at step S22 that the current line is the last line of the print data (step S22: Yes), the print speed control unit 101 ends the process.

As described above, the printer 10 of the present embodiment includes the stepping motor 4 for conveying the sheet 3 and the thermal head 1 disposed along a line direction that intersects or is orthogonal to the conveyance direction of the sheet 3. In addition, the printer 10 sets, for each of lines constituting print data, a print speed, at which a dot data set of the corresponding line is printed, based on the print ratio of dots included in the dot data set. When the print speed changes multiple times within a predetermined number of consecutive lines, the printer 10 changes the print speed s set for target dot data sets to a uniform print speed. Then, the printer 10 controls the stepping motor 4 to convey the sheet 3 toward the thermal head 1 at a print speed set for each dot data set to perform printing line by line.

As described above, in the printer 10 of the present embodiment, when the print speed changes multiple times within a predetermined number of consecutive lines, that is, when the print speed changes frequently, the print speeds of target dot data sets can be made constant to perform printing. Accordingly, with the printer 10, even when the print speed of print data changes frequently due to changes in the print ratio, it is possible to prevent the stepping motor 4 from stepping out and thereby improve printing quality. Therefore, the printer 10 can efficiently perform printing even with print data whose print ratio changes frequently.

It should be noted that the above-described embodiments can be modified and implemented as appropriate by changing a part of the configuration or the functions of the above-described apparatus. Therefore, variations of the above-described embodiment may be referred to as other embodiments. Below, differences from the above-described embodiment will be mainly described, and detailed descriptions of the same features as those of the above embodiment will be omitted. Also, variations described below may be implemented individually or in combination as appropriate.

### First Variation

In the above-described embodiment, the printer 10 performs printing on the sheet 3 that is a thermal sheet. However, the present disclosure is not limited to this example and may be applied to a printer that performs printing on the sheet 3 using an ink ribbon. Furthermore, the sheet 3 serving as a printing medium may be any type of sheet, such as receipt paper, label paper, or label paper having no backing paper (a so-called linerless label).

### Second Variation

In the above-described embodiment, print data is comprised of dot data sets. However, the printer 10 may be configured to generate print data from, for example, image data in a vector format.

In this case, the printer 10 may perform processing, such as rasterization, on image data before printing to convert the image data into print data in which a print target, such as characters or an image, is represented by dots. The conversion into the print data may be performed by the CPU 11 or may be performed by a conversion process unit that is provided separately as a functional component.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer comprising:
a roller that conveys a sheet in a conveyance direction;
a motor that drives the roller;
a print head disposed along a line direction intersecting the conveyance direction; and
a processor configured to:
set print speeds for dot data sets of lines to be printed based on a number of dots to be printed in each of the dot data sets,
change the set print speeds of target dot data sets among the dot data sets to a uniform print speed when the set print speeds of the dot data sets change multiple times within a predetermined number of consecutive lines, and
control the print head to print the dot data sets line by line on the sheet while controlling the motor to cause the roller to convey the sheet toward the print head at the set print speeds and the uniform print speed.

2. The printer according to claim 1, wherein when detecting a speed change involving a change in a speed change direction within the predetermined number of consecutive lines, the processor changes, to the uniform print speed, the set print speeds of the target dot data sets that are related to the speed change.

3. The printer according to claim 2, wherein the processor is configured to:
compare print speeds of dot data sets of each consecutive two lines, and
when detecting the speed change involving the change in the speed change direction within the predetermined number of consecutive lines after first detecting a speed change, change the set print speeds of the target dot data sets, which correspond to lines from a line at which the speed change is first detected to a line at which the speed change involving the change in the speed change direction is detected, to the uniform print speed.

4. The printer according to claim 3, wherein when first detecting an increase in print speed and then detecting a decrease in print speed within the predetermined number of lines after detecting the increase in print speed, the processor changes the set print speeds of the target dot data sets, which correspond to lines from a line at which the increase in print speed is detected to a line at which the decrease in print speed is detected, to the uniform print speed.

5. The printer according to claim 3, wherein when first detecting a decrease in print speed and then detecting an increase in print speed within the predetermined number of lines after detecting the decrease in print speed, the processor changes the set print speeds of the target dot data sets, which correspond to lines from a line at which the decrease in print speed is detected to a line at which the increase in print speed is detected, to the uniform print speed.

6. The printer according to claim 3, wherein the processor is configured to:
start counting a number of target lines when the speed change is first detected, and
change the set print speeds of the target dot data sets to the uniform print speed when the speed change involving the change in the speed change direction is detected while the counted number of target lines is within the predetermined number of consecutive lines.

7. The printer according to claim 6, wherein the processor is configured to clear the counted number of target lines after changing the set print speeds of the target dot data sets to the uniform print speed or when the counted number of target lines is greater than or equal to the predetermined number of lines.

8. The printer according to claim 1, wherein the processor is configured to change the set print speeds of the target print data sets to the uniform print speed that is a lowest one of the set print speeds of the target print data sets.

9. The printer according to claim 1, wherein the processor is configured to set a lower print speed for a print data set with a higher number of dots to be printed and set a higher print speed for a print data set with a lower number of dots to be printed.

10. The printer according to claim 1, wherein
the motor is a stepping motor, and
the predetermined number of lines is set based on a specification of the stepping motor to such a number of lines that the stepping motor tends to step out when the set print speeds change multiple times within the number of lines.

11. A method performed by a printer, the method comprising:
setting print speeds for dot data sets of lines to be printed based on a number of dots to be printed in each of the dot data sets;
changing the set print speeds of target dot data sets among the dot data sets to a uniform print speed when the set print speeds of the dot data sets change multiple times within a predetermined number of consecutive lines; and
printing the dot data sets line by line on a sheet while conveying the sheet toward a print head of the printer at the set print speeds and the uniform print speed.

12. The method according to claim 11, wherein when a speed change involving a change in a speed change direction is detected within the predetermined number of consecutive lines, the set print speeds of the target dot data sets related to the speed change are changed to the uniform print speed.

13. The method according to claim 12, further comprising:
comparing print speeds of dot data sets of each consecutive two lines, wherein
when the speed change involving the change in the speed change direction is detected within the predetermined number of consecutive lines after a speed change is first detected, the set print speeds of the target dot data sets, which correspond to lines from a line at which the speed change is first detected to a line at which the speed change involving the change in the speed change direction is detected, are changed to the uniform print speed.

14. The method according to claim 13, wherein when an increase in print speed is first detected and then a decrease in print speed is detected within the predetermined number of lines after the detection of the increase in print speed, the set print speeds of the target dot data sets, which correspond to lines from a line at which the increase in print speed is detected to a line at which the decrease in print speed is detected, are changed to the uniform print speed.

15. The method according to claim 13, wherein when a decrease in print speed is first detected and then an increase in print speed is detected within the predetermined number of lines after the detection of the decrease in print speed, the set print speeds of the target dot data sets, which correspond to lines from a line at which the decrease in print speed is detected to a line at which the increase in print speed is detected, are changed to the uniform print speed.

16. The method according to claim 13, further comprising:
starting to count a number of target lines when the speed change is first detected, wherein
the set print speeds of the target dot data sets are changed to the uniform print speed when the speed change involving the change in the speed change direction is detected while the counted number of target lines is within the predetermined number of consecutive lines.

17. The method according to claim 16, further comprising:
clearing the counted number of target lines after the set print speeds of the target dot data sets are changed to the uniform print speed or when the counted number of target lines is greater than or equal to the predetermined number of lines.

18. The method according to claim 11, wherein the set print speeds of the target dot data sets are changed to the uniform print speed that is a lowest one of the set print speeds of the target dot data sets.

19. The method according to claim 11, wherein a lower print speed is set for a print data set with a higher number of dots to be printed, and a higher print speed is set for a print data set with a lower number of dots to be printed.

20. A non-transitory computer readable storage medium storing a program for causing a processor of a printer to perform a process comprising:
setting print speeds for dot data sets of lines to be printed based on a number of dots to be printed in each of the dot data sets;
changing the set print speeds of target dot data sets among the dot data sets to a uniform print speed when the set print speeds of the dot data sets change multiple times within a predetermined number of consecutive lines; and
printing the dot data sets line by line on a sheet while conveying the sheet toward a print head of the printer at the set print speeds and the uniform print speed.
